(19) United States
(12) Patent Application Publication
(10) Pub. No.: US 2025/0174221 A1
(43) Pub. Date: May 29, 2025

(54) AUDIO SYSTEM AND METHOD

(71) Applicant: HARMAN BECKER AUTOMOTIVE SYSTEMS GmbH, Karlsbad-Ittersbach (DE)

(72) Inventors: Sebastian RIBECKY ARROYO, Munich (DE); Gleni LAMANI, Munich (DE); Friedrich von TÜRCKHEIM, Hamburg (DE)

(21) Appl. No.: 18/957,031

(22) Filed: Nov. 22, 2024

(30) Foreign Application Priority Data
Nov. 28, 2023 (EP) 23212578.1

(51) Int. Cl. G10K 15/08

(52) U.S. Cl. CPC G10K 15/08

(57) ABSTRACT

An audio system comprises a processing unit, and a reverb classification unit, wherein the reverb classification unit is configured to receive a first plurality of audio input signals, estimate a class of reverberation suitable for the first plurality of audio input signals using a deep learning (DL) classification algorithm, and output a prediction to the processing unit, the prediction including information concerning the estimated class of reverberation, and the processing unit is configured to receive the first plurality of audio input signals, generate a second plurality of audio output signals based on the first plurality of audio input signals, and output the second plurality of audio output signals, wherein generating the second plurality of audio output signals comprises adding reverberation to at least one of the second plurality of audio output signals based on the prediction received from the reverb classification unit.

### CROSS-REFERENCE TO RELATED APPLICATIONS

This application claims priority to European Patent Application titled, “AUDIO SYSTEM AND METHOD,” filed Nov. 28, 2023, and having Application No. EP 23212578.1. The subject matter of this related application is hereby incorporated herein by reference.

### TECHNICAL FIELD

The disclosure relates to an audio system and related method, in particular an audio system and method for adding reverberation to an audio signal.

### BACKGROUND

By extending an audio signal with surround or 3D information, e.g., adding a reverberation effect to an audio signal that matches a reverberation already existent in the audio signal, thereby simulating a certain listening environment, the listening experience of a user to whom the audio signal is presented can be significantly increased. An audio signal may be expanded, e.g., in the context of an upmixing process, by adding a reverberation which matches the original audio signal, or by creating additional reverberation channels or signals which match the existing audio signal. Acoustically simulating a concert hall, or any other kind of listening space by suitably adding and reproducing a matching reverberation, however, can be challenging. The resulting audio signal may comprise unwanted artifacts, may not be satisfying to listen to, and high computational load may be required to generate an extended audio signal.

There is a need for an audio system and related method that allow to simulate a listening environment by extending an audio signal with surround or 3D information, resulting in a highly satisfying listening experience for a listener, while requiring comparably little computational load.

### SUMMARY

An audio system includes a processing unit, and a reverb classification unit, wherein the reverb classification unit is configured to receive a first plurality of audio input signals, estimate a class of reverberation suitable for the first plurality of audio input signals using a deep learning (DL) classification algorithm, and output a prediction to the processing unit, the prediction including information concerning the estimated class of reverberation, and the processing unit is configured to receive the first plurality of audio input signals, generate a second plurality of audio output signals based on the first plurality of audio input signals, and output the second plurality of audio output signals, wherein generating the second plurality of audio output signals includes adding reverberation to at least one of the second plurality of audio output signals based on the prediction received from the reverb classification unit.

A method includes estimating a class of reverberation suitable for a first plurality of audio input signals using a deep learning (DL) classification algorithm, and make a prediction including information concerning the estimated class of reverberation, generating a second plurality of audio output signals based on the first plurality of audio input signals, wherein generating the second plurality of audio output signals includes adding reverberation to at least one of the second plurality of audio output signals based on the prediction, and outputting the second plurality of audio output signals.

Other systems, features and advantages of the disclosure will be or will become apparent to one with skill in the art upon examination of the following detailed description and figures. It is intended that all such additional systems, methods, features and advantages included within this description, be within the scope of the present disclosure and be protected by the following claims.

### BRIEF DESCRIPTION OF THE DRAWINGS

The arrangements and methods may be better understood with reference to the following description and drawings. The components in the figures are not necessarily to scale, emphasis instead being placed upon illustrating the principles of the disclosed embodiments. Moreover, in the figures, like referenced numerals designate corresponding parts throughout the different views.

FIG. 1 schematically illustrates an audio system according to embodiments of the disclosure.

FIG. 2 schematically illustrates a reverb classification unit according to embodiments of the disclosure.

FIG. 3 schematically illustrates different steps performed in a reverb classification unit according to embodiments of the disclosure.

FIG. 4 schematically illustrates an audio system according to further embodiments of the disclosure.

FIG. 5 schematically illustrates an audio system according to further embodiments of the disclosure.

FIG. 6 schematically illustrates a method according to embodiments of the disclosure.

### DETAILED DESCRIPTION

The audio system and related method according to the various embodiments described herein allow to simulate different listening environments by adding reverberation to an audio signal. Only comparably little computational load is required, and the resulting audio signal is highly satisfying to listen to, as it comprises only few or even no artifacts. Instead of “blindly” processing an audio signal as is done in conventional audio systems, the audio system and method disclosed herein preform an “informed” processing on an audio signal.

Generally, by adding 3D or surround information to an audio signal, the listening experience for a user listening to the audio signal can be significantly increased. Especially multi-channel playback provides the possibility of providing the impression to the user that they are located at a certain location or event, while listening to a musical piece. Additional ambience playback can create an envelopment that can be compared to the experience of being at a live event. For example, if a center signal of a multi-channel audio signal is extracted and added to a centrally positioned speaker, an optimum listening area (so-called sweet spot) can be enlarged and the stability of the front image can be significantly improved. Using 3D speakers, the feeling of a realistic immersion into an audio event can be improved further. There is even the possibility of lifting the stage and playing back overhead effects.

In order to improve the quality of a reproduced sound scene, the perception of the sound scene is often modeled as a combination of the foreground sound and the background sound, which are often also referred to as primary (or direct) and ambient (or diffuse) components, respectively. The primary components consist of point-like directional sound sources, whereas the ambient components are generally made up of diffuse environmental sound (reverberation). Due to perceptual differences between the primary components and the ambient components, different rendering schemes are generally applied to the primary components and the ambient components for optimal spatial audio reproduction of sound scenes. Channel-based audio, however, only provides mixed signals. Some approaches, therefore, focus on extracting the primary components and the ambient components from the mixed signals. Known methods which may include, e.g., ambience estimation in the frequency domain, often require a large computational load, and the resulting audio signal often is not satisfying to listen to, as it comprises a significant amount of artifacts.

The audio system and related method disclosed herein, in contrast to conventional methods, use artificial intelligence (deep learning, DL) algorithms in order to classify the spatial component of an existing audio signal, and further use this information in order to create artificial reverberation that matches the original reverberation. That is, instead of extracting the ambient components from the mixed signal, an environment in which a musical piece might have been recorded is estimated by using artificial intelligence. A musical piece generally includes a specific class of reverberation. The reverberation included in the musical piece generally has certain characteristics that are typical for the specific class of reverberation, e.g., long reverb tail, specific room modes, early reflections, etc. As a result, reverberation may be added to the audio signal that matches the reverberation included in the musical piece. That is, based on an estimated class of reverberation, for example, a matching artificial reverberation is added to the audio signal.

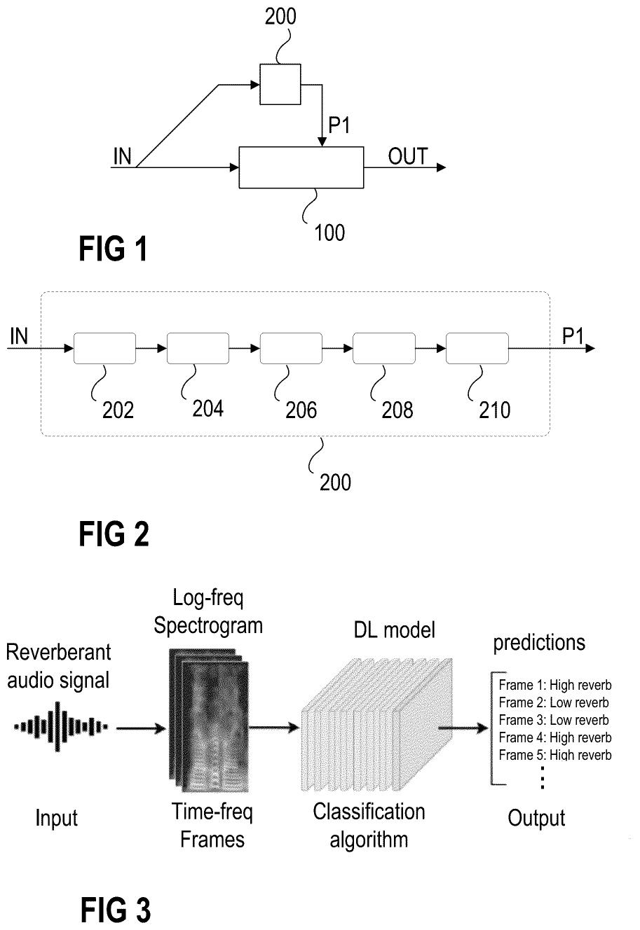

Now referring to FIG. 1, an audio system according to embodiments of the disclosure is schematically illustrated. The audio system comprises a processing unit 100, and a reverb classification unit 200. The reverb classification unit 200 is configured to receive a first plurality of audio input signals IN₁, . . . , IN_{N}, estimate a class of reverberation suitable for the first plurality of audio input signals IN₁, . . . , IN_{N} by using a deep learning, DL, classification algorithm, and output a prediction P1 to the processing unit 100, the prediction P1 including information concerning the estimated class of reverberation. The processing unit 100 is configured to receive the first plurality of audio input signals IN₁, . . . , IN_{N}, generate a second plurality of audio output signals OUT₁, . . . , OUT_{M} based on the first plurality of audio input signals IN₁, . . . , IN_{N}, and output the second plurality of audio output signals OUT₁, . . . , OUT_{M}, wherein generating the second plurality of audio output signals OUT₁, . . . , OUT_{M} comprises adding reverberation to at least one of the second plurality of audio output signals OUT₁, . . . , OUT_{M} based on the prediction P1 received from the reverb classification unit 200.

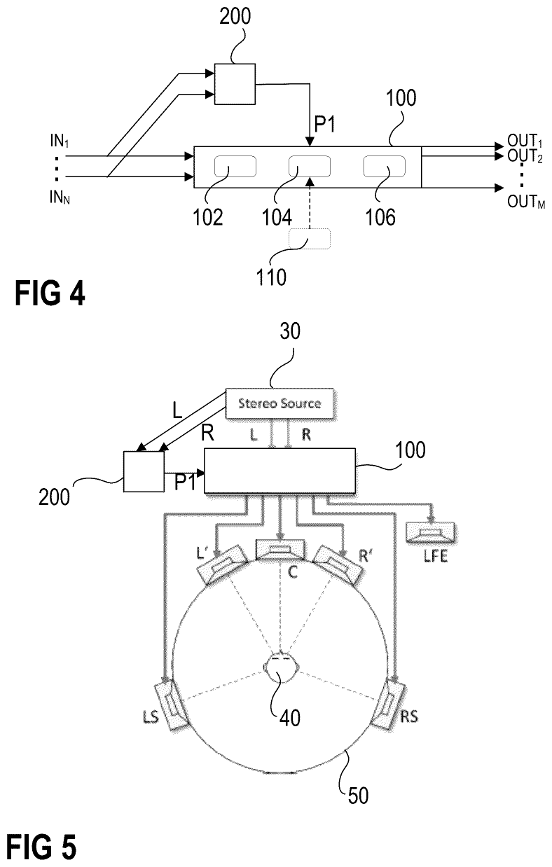

In FIG. 1, a single input signal IN and a single output signal OUT are schematically illustrated. However, there may be more than one input signal IN, and more than one output signal OUT, as is schematically illustrated in FIG. 4, for example. According to one example, the first plurality of audio input signals IN₁, . . . , IN_{N} may be two channels (e.g., left (L) and right (R) channel) of a stereo audio signal. The second plurality of audio output signals OUT₁, . . . , OUT_{M} may be the different channels (e.g., front left (FL) channel, front right (FR) channel, center (C) channel, surround left (LS) channel, surround right (RS) channel) of an upmixed 5.1 surround signal. Any other number N, M of input signals IN₁, . . . , IN_{N} and output signals OUT₁, . . . , OUT_{M}, with M≥N, however, is also possible. Reverberation may be added to each of a plurality of audio output signals OUT₁, . . . , OUT_{M}, or only to some of a plurality of audio output signals OUT₁, . . . , OUT_{M}. In a 5.1 surround signal, reverberation may only be added to the surround left (LS) and surround right (RS) channels of an upmixed 5.1 surround signal, to name just one example.

The reverb classification unit 200 is configured to estimate the class of reverberation suitable for the first plurality of audio input signals IN₁, . . . , IN_{N} (a class of reverberation that matches the first plurality of audio input signals IN₁, . . . , IN_{N}). According to some embodiments of the disclosure, estimating a class of reverberation suitable for the first plurality of audio input signals IN₁, . . . , IN_{N} comprises separating the first plurality of audio input signals IN₁, . . . , IN_{N} into a plurality of successive separate frames, extracting one or more features from each of the separate frames, each of the one or more features being characteristic for one of a plurality of types of listening environments, identifying a specific pattern in each of the separate frames based on the extracted features, and estimating a class of reverberation suitable for each of the separate frames based on the identified specific pattern. The length of each frame may influence the accuracy of the deep learning, DL, classification algorithm and may be chosen in any suitable way.

Referring to FIG. 2, a reverb classification unit 200 according to embodiments of the disclosure is schematically illustrated. The reverb classification unit 200 may comprise a receiving unit 202 configured to receive the first plurality of audio input signals IN₁, . . . , IN_{N}. The reverb classification unit 200 may further comprise a pre-processing unit 204. The pre-processing unit 204 may be configured to, in a first step, pre-process the input audio signal according to the requirements of the deep learning, DL, classification algorithm. The pre-processing unit 204 may re-sample the audio input signals to a target sampling rate and slice the audio input signals into frames of a defined length. The length of each frame may correspond to a desired temporal window for the output predictions. The reverb classification unit 200 may further comprise a feature extraction unit 206 that is configured to transform the separate signal frames into a signal representation that allows the classification algorithm to more easily identify patterns in the frames, the patterns being related to an amount of reverberation present in the respective frame of the audio input signal.

Suitable signal representations may include time-frequency representations such as, e.g., log-frequency spectrograms, for example. This is schematically illustrated in FIG. 3. FIG. 3 schematically illustrates that a log-frequency spectrogram may be generated for each of the different frames the audio input signal has been sliced into. A (log-frequency) spectrogram is a standard sound visualization tool, which allows to visualize the distribution of energy in both time and frequency. A log-frequency spectrogram is simply an image formed by the magnitude of the short-time Fourier transform, on a log-intensity axis (e.g., dB).

The transformed audio input signal frames (e.g., input samples) can then be processed in batches in a classification unit 208 using the classification algorithm. This results in a prediction of a suitable reverberation class for each of the audio input signal segments (frames). The reverb classification unit 200 may further comprise a prediction unit 210 that is configured to make and output the prediction P1 to the processing unit 100.

The reverb classification unit 200 may be configured to make a global prediction P1 based on the estimated classes of reverberation in a defined plurality of separate successive frames. The defined plurality of separate successive frames may constitute a musical piece, and the global prediction P1 may include information concerning the estimated class of reverberation suitable for the entire musical piece. That is, a musical piece may be separated into a plurality of separate frames. A suitable reverberation may be determined for each of the plurality of separate frames. For example, a suitable reverberation may either be “high reverberation” or “low reverberation”. If it is determined that within the plurality of separate frames of a musical piece the result “high reverberation” is predominant as compared to “low reverberation”, high reverberation may be added to the entire musical piece, or vice versa. “High reverberation”, and “low reverberation”, however, are merely examples. Other classes of reverberation may include, but are not limited to, e.g., “large/medium/small Jazz hall”, “large/medium/small living room”, “wooden large/medium/small concert hall”, etc. Other even more generic classes of reverberation may include “Hall 1”, “Hall 2”, “Hall 3”, etc.

Alternatively, it is also possible that a sub-prediction P1 is made based on the estimated classes of reverberation in a sub-set of a defined plurality of separate successive frames. The defined plurality of separate successive frames may constitute a musical piece, and the sub-prediction P1 may include information concerning the estimated class of reverberation suitable for a fraction of the musical piece. That is, a musical piece may be separated into a plurality of separate frames. A suitable reverberation may be determined for each of the plurality of separate frames. For example, a suitable reverberation may either be “high reverberation” or “low reverberation”. A different reverberation may be added to each of the different frames of the audio input signal based on the respective predictions. It is, however, also possible to make a combined prediction for several of the separate frames, but not to all.

Referring to FIG. 3, a suitable reverberation may be determined for each of the plurality of frames, resulting in the predictions illustrated on the right side of FIG. 3. Several frames, e.g., frames 1 to 5 (or any other number of frames) may then be combined to a group of frames and a sub-prediction P1 may be determined and output for this group of frames. If, in the example illustrated in FIG. 3, frames 1 to 5 are combined, the result “high reverberation” is predominant. That is, the sub-prediction P1 “high reverberation” may be output to the processing unit 100, which may then add “high reverberation” to respective frames 1 to 5. A musical piece, however, may comprise more than frames 1 to 5. That is, different reverberation may be added to different segments of a musical piece, each segment comprising more than one frame. This allows to add reverberation to a musical piece in a very accurate way, resulting in a very satisfying listening experience.

The deep learning, DL, classification algorithm may be based on a deep learning, DL, model, wherein the DL model is trained using annotated data consisting of audio signals with different known grades of reverberation. The DL model may learn hierarchical representations from input samples, for example. In order to be able to predict reverberation classes with a high accuracy, it may be trained with annotated data consisting of audio signals with different known grades of reverberation. The grades of reverberation may be perceptually measured, for example. One or more different databases may generally be used for this purpose. The one or more databases may be obtained in any suitable way.

The audio systems described herein are able to directly classify an amount of reverberation present in an audio input signal, which is directly aligned with the perceptual measure for reverberation. The audio signal is highly flexible concerning the amount of reverberation classes that can be estimated. According to one example, two reverberation classes, e.g., “high reverberation” and “low reverberation” may be estimated. According to another example, three reverberation classes, e.g., “high reverberation”, “mid reverberation”, and “low reverberation” may be estimated, wherein “mid reverberation” is a reverberation that is less than “high reverberation” and greater than “low reverberation”. Any other intermediate reverberation classes between “high reverberation” and “low reverberation” may generally be estimated as well. As mentioned above, other additional or alternative classes of reverberation may include, but are not limited to, e.g., “large/medium/small Jazz hall”, “large/medium/small living room”, “wooden large/medium/small concert hall”, “Hall 1”, “Hall 2”, “Hall 3”, etc.

The audio systems described above may be surround sound systems, or any kind of 3D audio systems (e.g., VR/AR applications), for example. That is, the number of audio input signals included in the first plurality of audio input signals IN₁, . . . , IN_{N} may equal the number of audio signals included in the second plurality of audio output signals OUT₁, . . . , OUT_{M}, as is illustrated in FIG. 1. It is, however, also possible that the number of audio input signals included in the first plurality of audio input signals IN₁, . . . , IN_{N} is less than the number of audio signals included in the second plurality of audio output signals OUT₁, . . . , OUT_{M}, as is schematically illustrated in FIGS. 4 and 5 (N<M). That is, the processing unit 100 may be or may comprise an upmixing processor 102, as is exemplarily illustrated in FIG. 4.

A surround sound system is schematically illustrated in FIG. 5. The surround sound system comprises a stereo source 30. The processing unit 100 may receive a first plurality of audio input signals IN₁, . . . , IN_{N} from the stereo source 30, e.g., two channels (left (L) and right (R) channel) of a stereo audio signal. The second plurality of audio output signals OUT₁, . . . , OUT_{M} may be the different channels (e.g., front left (L′) channel, front right (R′) channel, center (C) channel, surround left (LS) channel, surround righ (RS) channel) of an upmixed 5.1 surround signal. A plurality of loudspeakers may be arranged in a listening environment 50. The loudspeakers may be arranged at suitable positions with respect to a listener 40 present in the listening environment 50. The different channels of the audio output signal OUT may be fed to the respective loudspeakers. A surround sound system as exemplarily illustrated in FIGS. 4 and 5, may generate artificial spatiality (ambience) in order to achieve an acoustic envelopment of the listener 40 in the listening environment 50. The output signals generated by the surround sound system may be routed to the surround and height channels of a multi-channel speaker system.

The reverberation added to the one or more audio output signals OUT₁, . . . , OUT_{M} may be generated based on the prediction P1 (e.g., by using a reverberation engine 104) as exemplarily illustrated in FIG. 4. For example, the spatial information (prediction P1) obtained and provided by the reverb classification unit 200 may be used to adjust parameters of an artificial reverb generator algorithm (reverb engine 104). That is, for different predictions P1 received from the reverb classification unit 200, a reverb engine 104 may apply different parameters when generating artificial reverberation. The artificially generated reverberation may be then fed to a distribution block 106 of the processing unit 100. The distribution block 106 may route the reverberation (“ambience” signal component) to the desired speakers (e.g., the surround and/or height speakers of a surround sound system) according to a desired upmixing setting.

It is, however, also possible that the processing unit 100 comprises or is coupled to a memory 110, wherein different types of reverberation are stored in the memory 110. The processing unit 100 (e.g., a reverberation engine 104 of the processing unit 100), based on the prediction P1, can retrieve a suitable reverberation from the memory 110 and add it to the one or more audio output signals OUT₁, . . . , OUT_{M} accordingly.

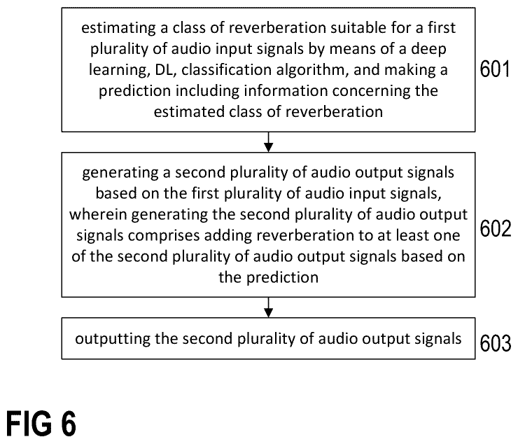

Referring to FIG. 6, a method according to embodiments of the disclosure comprises estimating a class of reverberation suitable for a first plurality of audio input signals IN₁, . . . , IN_{N} by using a deep learning, DL, classification algorithm, and make a prediction P1 including information concerning the estimated class of reverberation (step 601), and generating a second plurality of audio output signals OUT₁, . . . , OUT_{M} based on the first plurality of audio input signals IN₁, . . . , IN_{N}, wherein generating the second plurality of audio output signals OUT₁, . . . , OUT_{M} comprises adding reverberation to at least one of the second plurality of audio output signals OUT₁, . . . , OUT_{M} based on the prediction P1 (step 602). The method further comprises outputting the second plurality of audio output signals OUT₁, . . . , OUT_{M} (step 603).

According to some embodiments of the disclosure, estimating a class of reverberation suitable for the first plurality of audio input signals IN₁, . . . , IN_{N} may comprise separating the first plurality of audio input signals IN₁, . . . , IN_{N} into a plurality of successive separate frames, extracting one or more features from each of the separate frames, each of the one or more features being characteristic for one of a plurality of types of listening environments, identifying a specific pattern in each of the separate frames by using the extracted features, and estimating a class of reverberation suitable for each of the separate frames based on the identified specific pattern.

According to some embodiments, the method may further comprise, after separating the first plurality of audio input signals IN₁, . . . , IN_{N} into a plurality of successive separate frames and before extracting one or more features from each of the separate frames, transforming the separate signal frames into a log-frequency spectrogram.

The artificially generated spatiality matches the (possibly) existing spatiality present in the original audio signal (first plurality of audio input signals IN₁, . . . , IN_{N}). Ideally, it has the same room acoustic properties. Classic ambience extraction methods that may be used to extract the original ambience signal from an input signal are algorithmically complex and cause perceptually relevant artefacts. A multiplication and distribution of an extracted ambience signal to the speaker channels of a multi-channel system further increases the perceived artefacts. The audio system described above overcomes these drawbacks. The reverberation class information of the ambience portion of the original signal is used to control or configure an algorithm that artificially generates the output ambience signals. The manner in which the artificial ambience component is created is generally not relevant. The artificial ambience component may generally be created in any suitable way. Any type of reverb method can generally be used (e.g., Feedback Delay Networks (FDNs), convolution reverb, etc.)

Based on the requirements of the specific application (e.g., upmix technology), the number and semantic properties of the reverb classes are adjusted, and the deep learning, DL, classification network may be trained accordingly. Further, the classes may be defined based on perceptually relevant characteristics (e.g., reverberation length, density of reflections, early reflection patterns, dry/wet ratio, decay rate, spectral behavior, etc.), and the artificial reverberation algorithm may be configured accordingly. For example, if the DL network was trained to estimate reverberation lengths in the input signal, the output predictions can be used to set the same parameter in an artificial reverb engine.

It may be understood, that the illustrated systems are merely examples. While various embodiments have been described, it will be apparent to those of ordinary skill in the art that many more embodiments and implementations are possible within the scope of the present disclosure. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the present disclosure is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plurals of the elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. An audio system comprising
a processing unit; and
a reverb classification unit configured to:
receive a first plurality of audio input signals;
estimate a class of reverberation suitable for the first plurality of audio input signals via a deep learning classification algorithm; and
output a prediction to the processing unit, the prediction including the estimated class of reverberation suitable for the first plurality of audio input signals; and
wherein the processing unit is configured to:
receive the first plurality of audio input signals;
generate a second plurality of audio output signals based on the first plurality of audio input signals including adding reverberation to at least one of the second plurality of audio output signals based on the prediction received from the reverb classification unit; and
output the second plurality of audio output signals.

2. The audio system of claim 1, wherein estimating the class of reverberation comprises:
separating the first plurality of audio input signals into a plurality of successive frames; and
for each frame in the plurality of successive frames:
extracting one or more features from the frame, each of the one or more features being characteristic for one of a plurality of types of listening environments;
identifying a specific pattern in the frame based on the one or more features; and
estimating a class of reverberation suitable for the frame based on the specific pattern to generate a plurality of estimated classes of reverberation for the plurality of successive frames.

3. The audio system of claim 2, further comprising, after separating the first plurality of audio input signals into the plurality of successive frames and before extracting one or more features from each frame in the plurality of successive frames, transforming each frame in the plurality of successive frames into a log-frequency spectrogram.

4. The audio system of claim 2, further comprising computing a global prediction based on the plurality of estimated classes of reverberation for the plurality of successive frames.

5. The audio system of claim 4, wherein the plurality of successive frames comprises a musical piece, and the global prediction includes an estimated class of reverberation suitable for the musical piece.

6. The audio system of claim 2, further comprising making a sub-prediction based on a sub-set of the plurality of estimated classes of reverberation for the plurality of successive frames.

7. The audio system of claim 6, wherein the plurality of successive frames comprises a musical piece, and the sub-prediction includes an estimated class of reverberation suitable for a sub-set of the musical piece.

8. The audio system of claim 1, wherein a number of audio signals included in the first plurality of audio input signals equals a number of audio signals included in the second plurality of audio output signals.

9. The audio system of claim 1, wherein a number of audio signals included in the first plurality of audio input signals is less than a number of audio signals included in the second plurality of audio output signals.

10. The audio system of claim 1, wherein the first plurality of audio input signals includes two channels of a stereo signal, and the second plurality of audio output signals include five channels of a 5.1 surround signal.

11. The audio system of claim 1, wherein the deep learning classification algorithm is based on a deep learning model that is trained using annotated data comprising audio signals with different grades of reverberation.

12. The audio system of claim 1, wherein the estimated class of reverberation suitable for the first plurality of audio input signals is at least one of a low reverberation, a mid reverberation, or a high reverberation.

13. A computer-implemented method, the method comprising:
estimating a class of reverberation suitable for a first plurality of audio input signals via a deep learning classification algorithm;
determine a prediction including the estimated class of reverberation suitable for the first plurality of audio input signals;
generating a second plurality of audio output signals based on the first plurality of audio input signals including adding reverberation to at least one of the second plurality of audio output signals based on the prediction; and
outputting the second plurality of audio output signals.

14. The method of claim 13, wherein estimating the class of reverberation comprises:
separating the first plurality of audio input signals into a plurality of successive frames; and
for each frame in the plurality of successive frames:
extracting one or more features from the frame, each of the one or more features being characteristic for one of a plurality of types of listening environments;
identifying a specific pattern in the frame based on the one or more features; and
estimating a class of reverberation suitable for the frame based on the specific pattern to generate a plurality of estimated classes of reverberation for the plurality of successive frames.

15. The method of claim 14, further comprising, after separating the first plurality of audio input signals into the plurality of successive frames and before extracting one or more features from each frame in the plurality of successive frames, transforming each frame in the plurality of successive frames into a log-frequency spectrogram.

16. The method of claim 14, further comprising computing a global prediction based on the plurality of estimated classes of reverberation for the plurality of successive frames.

17. The method of claim 16, wherein the plurality of successive frames comprises a musical piece, and the global prediction includes an estimated class of reverberation suitable for the musical piece.

18. The method of claim 14, further comprising making a sub-prediction based on a sub-set of the plurality of estimated classes of reverberation for the plurality of successive frames.

19. The method of claim 18, wherein the plurality of successive frames comprises a musical piece, and the sub-prediction includes an estimated class of reverberation suitable for a sub-set of the musical piece.

20. The method of claim 13, wherein the first plurality of audio input signals include two channels of a stereo signal, and the second plurality of audio output signals include five channels of a 5.1 surround signal.
